(19) United States
(12) Patent Application Publication
(10) Pub. No.: US 2026/0264069 A1
(43) Pub. Date: Sep. 10, 2026

(54) METAL PHOSPHIDE-GRAPHENE AEROGEL CATALYST FOR HYDROLYSIS OF AMMONIA BORANE, METHOD FOR PREPARING THE SAME, AND HYDROGEN PRODUCTION SYSTEM FOR HYDROLYSIS OF AMMONIA BORANE COMPRISING THE SAME

(71) Applicant: THE HONG KONG POLYTECHNIC UNIVERSITY, Hong Kong (CN)

(72) Inventors: Fujing XU, Hong Kong (CN); Guangping ZHENG, Hong Kong (CN)

(21) Appl. No.: 19/071,134

(22) Filed: Mar. 5, 2025

(51) Int. Cl. B01J 37/34; B01J 4/00; B01J 19/24; B01J 21/18; B01J 27/185; B01J 35/23; B01J 35/45; B01J 35/51; B01J 37/10; B01J 37/32; C01B 3/06

(52) U.S. Cl. CPC B01J 37/348; B01J 4/007; B01J 19/2425; B01J 19/2435; B01J 21/18; B01J 27/1853; B01J 35/23; B01J 35/45; B01J 35/51; B01J 37/10; B01J 37/32; C01B 3/065; B01J 2204/002

(57) ABSTRACT

A metal phosphide-graphene aerogel catalyst for hydrolysis of ammonia borane, including: a graphene aerogel in a three-dimensional porous structure, and metal phosphide nanoparticles, which are spherical with an average particle size of 3-100 nm, uniformly deposited on the graphene aerogel, and include a phosphorus element and a transition metal element. The transition metal element may be cobalt, nickel, iron, zinc, titanium, vanadium, chromium, manganese, copper, or any combination thereof. A method for preparing the metal phosphide-graphene aerogel catalyst, includes: preparing the graphene aerogel by performing a hydrothermal process on a graphene oxide and a reducing agent; preparing an electrolyte, including a phosphorus-containing compound, a transition metal compound, disodium citrate, boric acid, and deionized water in a mass ratio of (1-2):(1-2):(2-4):(1-2):(90-95); and electro-depositing the metal phosphide onto the graphene aerogel. A hydrogen production system for hydrolysis of ammonia borane including the same catalyst is also provided.

### BACKGROUND

### Technical Field

The present application relates to the technical field of hydrogen production, more particularly to a metal phosphide-graphene aerogel catalyst for hydrolysis of ammonia borane, a method for preparing the same, and a hydrogen production system for hydrolysis of ammonia borane comprising the same.

### Description of Related Art

Hydrogen energy, as a clean and efficient renewable energy source, is pivotal in global energy transitions. Unlike fossil fuels, it does not produce carbon dioxide or other greenhouse gases, making it environmentally friendly and a key solution to combat climate change. With the global push toward reducing carbon emissions and achieving carbon neutrality, hydrogen technology has gained significant attention. However, traditional hydrogen production and storage methods suffer from low efficiency, safety issues, and high costs, hindering widespread adoption. Therefore, developing efficient, safe, and cost-effective hydrogen production and storage technologies is critical.

Ammonia borane (AB), a solid hydrogen storage material with high hydrogen content, has attracted attention for its ability to release hydrogen efficiently through hydrolysis at room temperature. The hydrolysis process involves key steps such as adsorption, activation, and hydrogen release, typically requiring a catalyst for efficiency. While traditional catalysts based on precious metals like platinum and palladium show high activity, their high cost and limited availability restrict large-scale use. Hence, developing a cost-effective, high-performance catalyst is essential for advancing ammonia borane hydrolysis in hydrogen energy applications.

Graphene aerogel (GA), a three-dimensional porous material composed of graphene nanosheets, is an ideal catalyst support due to its high surface area, excellent conductivity, and outstanding chemical and thermal stability. Its three-dimensional network provides abundant active sites and facilitates electron transfer, enhancing catalytic reactions. However, a key challenge remains in uniformly loading active catalysts onto graphene aerogel while maintaining its structural stability.

Despite progress in developing efficient catalysts for ammonia borane hydrolysis, most research has focused on catalyst performance rather than integrated catalyst and hydrogen generation system design. This limitation has slowed the commercialization of ammonia borane hydrolysis for hydrogen production. Current systems face challenges in catalyst loading, reaction efficiency, hydrogen release control, and safety. Developing an integrated, stable, and user-friendly hydrogen generation system is vital to overcome these barriers and enable industrial-scale application.

Existing hydrogen generation systems lack holistic optimization, limiting the practical use of even the best-performing ammonia borane hydrolysis catalysts. Low system efficiency, imprecise hydrogen release, and operational complexity hinder commercial adoption. Therefore, an integrated hydrogen generation system based on metal phosphide-graphene aerogel catalysts is urgently needed. This system would efficiently catalyze ammonia borane hydrolysis while ensuring stability, reliability, and cost-effectiveness, accelerating the commercialization of hydrogen energy technologies.

### SUMMARY

In view of the above-described problems, among others, one of the objectives of the present application is to provide a metal phosphide-graphene aerogel catalyst for hydrolysis of ammonia borane, a method for preparing the same, and a hydrogen production system for hydrolysis of ammonia borane comprising the same, which aims to solve the technical problems that the existing technology lacks an efficient integrated catalyst for hydrolysis of ammonia borane and the hydrogen generation systems faces challenges in catalyst loading, reaction efficiency, hydrogen release control, and safety.

To achieve the above objective, in accordance with an embodiment of a first aspect of the present application, there is provided a metal phosphide-graphene aerogel catalyst for hydrolysis of ammonia borane, which comprises: a graphene aerogel in a three-dimensional porous structure, and metal phosphide nanoparticles, which are uniformly deposited on the graphene aerogel and comprise a phosphorus element and a transition metal element. The transition metal element is at least one selected from the group consisting of cobalt, nickel, iron, zinc, titanium, vanadium, chromium, manganese, copper, or any combination thereof. The metal phosphide nanoparticles exhibit spherical morphologies and have an average particle size of between 3 nm and 200 nm

In accordance with an embodiment of a second aspect of the present application, there is provided a method for preparing the metal phosphide-graphene aerogel catalyst for hydrolysis of ammonia borane as provided in the first aspect, The method comprises:
preparing the graphene aerogel by performing a hydrothermal process on a graphene oxide and a reducing agent; in which, the reducing agent is one selected from ascorbic acid, hydrazine hydrate, or sodium borohydride;
preparing an electrolyte, comprising a phosphorus-containing compound, a transition metal compound, disodium citrate, boric acid, and deionized water in a mass ratio of (1-2):(1-2):(2-4):(1-2):(90-95); and
electro-depositing the metal phosphide onto the graphene aerogel, whereby obtaining the metal phosphide-graphene aerogel catalyst.

In accordance with an embodiment of a third aspect of the present application, there is provided a hydrogen production system for hydrolysis of ammonia borane. The hydrogen production system comprises: a catalytic unit tube, configured to accommodate the metal phosphide-graphene aerogel catalyst provided by the first aspect of the present application or a catalyst prepared by the method for preparing the metal phosphide-graphene aerogel catalyst for hydrolysis of ammonia borane provided by the second aspect of the present application; a container, configured to accommodate an ammonia borane solution; a peristaltic pump, configured to drive a solution flow from the container to pass through the catalytic unit tube; liquid pipelines; and a gas collection system, connected via a gas pipe to the container to collect a hydrogen output. The container, the peristaltic pump, and the catalytic unit tube are sequentially connected via the liquid pipelines to form a circulation loop, such that the solution flow continuously circulates in the circulation loop under the driving of the peristaltic pump.

Beneficial effects of the embodiments of the present application are summarized as follows:

In the metal phosphide-graphene aerogel catalyst for hydrolysis of ammonia borane provided by the first aspect of the present application, the catalyst comprises: a graphene aerogel in a three-dimensional porous structure, and metal phosphide nanoparticles uniformly deposited on the graphene aerogel. The three-dimensional porous graphene aerogel has large surface area, excellent thermal stability, and robust mechanical performance, the metal phosphide nanoparticles are uniformly electro-deposited on the graphene aerogel, the bonding strength between the metal phosphide nanoparticles and the graphene aerogel is very high, thus, the integrated metal phosphide-graphene aerogel catalyst has high structural stability. Compared with the conventional metal phosphide catalysts which may easily agglomerate, the integrated metal phosphide-graphene aerogel catalyst provided by the embodiments of the present application has large surface area and abundant active sites, thus providing enhanced catalytic performance.

In the method for preparing the metal phosphide-graphene aerogel catalyst for hydrolysis of ammonia borane provided by the second aspect of the present application, the graphene aerogel is provided by performing a hydrothermal process on a graphene oxide and a reducing agent, in which, the reducing agent is one selected from ascorbic acid, hydrazine hydrate, or sodium borohydride; the electrolyte comprising a phosphorus-containing compound, a transition metal compound, disodium citrate, boric acid, and deionized water in a mass ratio of (1-2):(1-2):(2-4):(1-2):(90-95) is provided; and the metal phosphide is electro-deposited onto the graphene aerogel, whereby obtaining the metal phosphide-graphene aerogel catalyst. In this embodiment, the reaction product of a transition metal compound and a phosphorus-containing compound is uniformly deposited onto the surface of the graphene aerogel via an electrodeposition process, forming a high-efficiency catalyst for ammonia borane hydrolysis. This method does not require high temperature or high pressure, ensuring the integrity of the three-dimensional structure and preserving abundant active sites, thereby maintaining the catalyst's high efficiency. Moreover, the reaction process involves no toxic or harmful chemicals, adhering to the principles of green chemistry.

In the third aspect of the present application, the hydrogen production system comprises: a catalytic unit tube, configured to accommodate the metal phosphide-graphene aerogel catalyst provided by the first aspect of the present application or a catalyst prepared by the method for preparing the metal phosphide-graphene aerogel catalyst for hydrolysis of ammonia borane provided by the second aspect of the present application; a container, configured to accommodate an ammonia borane solution; a peristaltic pump, configured to drive a solution flow from the container to pass through the catalytic unit tube; liquid pipelines; and a gas collection system, connected via a gas pipe to the container to collect a hydrogen output. The container, the peristaltic pump, and the catalytic unit tube are sequentially connected via the liquid pipelines to form a circulation loop, such that the solution flow continuously circulates in the circulation loop under the driving of the peristaltic pump. The catalyst adopted is the metal phosphide-graphene aerogel composite catalyst provided by the present application, which has high structural stability, large surface area, and abundant active sites, thus providing enhanced catalytic performance. The system can operate at room temperature, making it suitable for both portable and stationary hydrogen generation applications. In this way, the hydrogen production system of the present application can efficiently catalyze ammonia borane hydrolysis while ensuring stability, reliability, and cost-effectiveness, accelerating the commercialization of hydrogen energy technologies.

### BRIEF DESCRIPTION OF THE DRAWINGS

Embodiments of the present invention are described in more detail hereinafter with reference to the accompanying drawings, in which:

FIG. 1 shows a scanning electron microscope (SEM) image of the graphene aerogel according to an embodiment of the present application, specifically, part (a) of FIG. 1 is an SEM image of the graphene aerogel with a scale bar of 50 μm, and part (b) of FIG. 1 is an SEM image of the graphene aerogel with a scale bar of 5 μm.

FIG. 2 shows a high-resolution transmission electron microscope (HRTEM) image and selected area electron diffraction (SAED) pattern of the electrodeposited graphene aerogel according to an embodiment of the present application, specifically, part (a) of FIG. 2 is an HRTEM image of the electrodeposited graphene aerogel with a scale bar of 50 μm, part (b) of FIG. 2 is an HRTEM image of the electrodeposited graphene aerogel with a scale bar of 10 μm, and part (c) of FIG. 2 is an image showing the SAED pattern of the electrodeposited graphene aerogel;

FIG. 3 shows a plot of hydrogen generation versus time based on the Co—P@GA catalyst according to an embodiment of the present application;

FIG. 4 shows a schematic diagram of the ammonia borane hydrolysis catalytic unit tube according to an embodiment of the present application;

FIG. 5 shows a schematic diagram of a hydrogen production system 20 for hydrolysis of ammonia borane according to an embodiment of the present application, illustrating the integrated components and system flow according to an embodiment of the present application;

FIG. 6 shows a photo of a hydrogen production system for hydrolysis of ammonia borane according to an embodiment of the present application, in which, eight catalytic unit tubes are connected in parallel to form a larger catalytic section;

FIG. 7 shows a plot of hydrogen generation over time for a unit-tube catalyst at a peristaltic pump speed of 100 RPM according to an embodiment of the present application;

FIG. 8 shows a plot of hydrogen generation over time for a unit-tube catalyst at various flow rates according to an embodiment of the present application; and

FIG. 9 shows a plot of hydrogen generation overtime after a half-hour cycle.

### DETAILED DESCRIPTION OF THE ENABLING EMBODIMENTS

For further illustrating the invention, experiments detailing a metal phosphide-graphene aerogel catalyst for hydrolysis of ammonia borane, a method for preparing the same, and a hydrogen production system for hydrolysis of ammonia borane comprising the same are described below. It should be noted that the following examples are intended to describe and not to limit the invention.

In a first aspect, an embodiment of the present application provides a metal phosphide-graphene aerogel catalyst for hydrolysis of ammonia borane, which comprises: a graphene aerogel in a three-dimensional porous structure, and metal phosphide nanoparticles, which are uniformly deposited on the graphene aerogel and comprise a phosphorus element and a transition metal element. The transition metal element is at least one selected from the group consisting of cobalt, nickel, iron, zinc, titanium, vanadium, chromium, manganese, copper, or any combination thereof. The metal phosphide nanoparticles exhibit spherical morphologies and have an average particle size of between 3 nm and 200 nm.

In the metal phosphide-graphene aerogel catalyst for hydrolysis of ammonia borane provided by the first aspect of the present application, the catalyst comprises: a graphene aerogel in a three-dimensional porous structure, and metal phosphide nanoparticles uniformly deposited on the graphene aerogel. The three-dimensional porous graphene aerogel has large surface area, excellent thermal stability, and robust mechanical performance, the metal phosphide nanoparticles are uniformly electro-deposited on the graphene aerogel, the bonding strength between the metal phosphide nanoparticles and the graphene aerogel is very high, thus, the integrated metal phosphide-graphene aerogel catalyst has high structural stability. Compared with the conventional metal phosphide catalysts which may easily agglomerate, the integrated metal phosphide-graphene aerogel catalyst provided by the embodiments of the present application has large surface area and abundant active sites, thus providing enhanced catalytic performance.

It should be understood that theoretically, the transitional metal element can be any transitional metal element capable of forming complexes with sulfate (SO₄²⁻) and chloride ions (Cl⁻). In an embodiment of the present application, the transition metal is at least one selected from the group consisting of cobalt, nickel, iron, zinc, or a combination thereof.

In an embodiment, the metal phosphide nanoparticles are Co—Ni—P nanoparticles.

In an embodiment, the metal phosphide nanoparticles are Co—P nanoparticles.

In an embodiment, an atomic ratio of the phosphorus element to the transition metal element is between (1:10) and (3:1). In an embodiment of the present application, the atomic ratio of the phosphorus element to the transition metal element may be between (1:2) and (2:1).

In an embodiment, the metal phosphide nanoparticles exhibit spherical morphologies.

The size of the nanoparticles may vary. In an embodiment, an average particle size of the metal phosphide nanoparticles may be 3 nm, 4 nm, 5 nm, 6 nm, 7 nm, 8 nm, 9 nm, 10 nm, . . . , 100 nm, . . . or 200 nm, or any value between 3 nm and 200 nm. In a preferred embodiment, an average particle size of the metal phosphide nanoparticles may be 5 nm. It should be understood that the nanoparticles should be controlled at a proper size, an oversize of the nanoparticles may result in micron-sized aggregates, which may negatively affect the catalytic activity.

In a second aspect, an embodiment of the present application provides a method for preparing the metal phosphide-graphene aerogel catalyst for hydrolysis of ammonia borane as mentioned in the above, The method comprises:
preparing the graphene aerogel by performing a hydrothermal process on a graphene oxide and a reducing agent; in which, the reducing agent is one selected from ascorbic acid, hydrazine hydrate, or sodium borohydride;
preparing an electrolyte, comprising a phosphorus-containing compound, a transition metal compound, disodium citrate, boric acid, and deionized water in a mass ratio of (1-2):(1-2):(2-4):(1-2):(90-95); and
electro-depositing the metal phosphide onto the graphene aerogel, whereby obtaining the metal phosphide-graphene aerogel catalyst.

In the method for preparing the metal phosphide-graphene aerogel catalyst for hydrolysis of ammonia borane provided by the second aspect of the present application, the graphene aerogel is provided by performing a hydrothermal process on a graphene oxide and a reducing agent, in which, the reducing agent is one selected from ascorbic acid, hydrazine hydrate, or sodium borohydride; the electrolyte comprising a phosphorus-containing compound, a transition metal compound, disodium citrate, boric acid, and deionized water in a mass ratio of (1-2):(1-2):(2-4):(1-2):(90-95) is provided; and the metal phosphide is electro-deposited onto the graphene aerogel, whereby obtaining the metal phosphide-graphene aerogel catalyst. In this embodiment, the reaction product of a transition metal compound and a phosphorus-containing compound is uniformly deposited onto the surface of the graphene aerogel via an electrodeposition process, forming a high-efficiency catalyst for ammonia borane hydrolysis. This method does not require high temperature or high pressure, ensuring the integrity of the three-dimensional structure and preserving abundant active sites, thereby maintaining the catalyst's high efficiency. Moreover, the reaction process involves no toxic or harmful chemicals, adhering to the principles of green chemistry.

In an embodiment, the step of preparing the graphene aerogel by performing the hydrothermal process on the graphene oxide and the reducing agent comprises:
adding the reducing agent to an aqueous dispersion solution of the graphene oxide and stirring until the reducing agent is completely dissolved;
heating a resulting mixed solution at a temperature of 60° C. to 70° C. for 3 hrs to 4 hrs to obtain a graphene hydrogel; and
pre-cooling the graphene hydrogel at a temperature of −55° C. to −60° C. for 2 hrs to 3 hrs, followed by freeze-drying for 48 hrs to 50 hrs, whereby obtaining the graphene aerogel.

In this embodiment, the graphene aerogel is prepared by freeze-drying the graphene hydrogel. The obtained graphene aerogel possesses a three-dimensional porous structure with a high surface area.

In an embodiment, prior to adding the reducing agent, the aqueous dispersion solution of the graphene oxide is stirred at room temperature at a speed of 500 RPM to 700 RPM for at least 30 minutes.

In an embodiment, the reducing agent is added to the aqueous dispersion solution of graphene oxide and stirred at room temperature at a speed of 500 RPM to 700 RPM for at least 1 hr.

In an embodiment, the preparation process of the graphene aerogel involves adding a reducing agent, such as ascorbic acid, to a water-dispersed solution of graphene oxide after rapid stirring at room temperature (20° C.-25° C.) for 30 minutes. The reducing agent effectively removes oxygen-containing functional groups from graphene oxide, leading to the formation of pure graphene sheets. These sheets interact via hydrogen bonding and x-x stacking, forming a three-dimensional porous graphene hydrogel network. The mixture is then stirred for an additional 1 hr to ensure complete dissolution. The resulting solution is heated at 60° C. to 70° C. for 3 hrs to 4 hrs to facilitate the formation of graphene hydrogel. Subsequently, the hydrogel is pre-cooled at −55° C. to −60° C. for 2 hrs to 3 hrs and freeze-dried for 48 hrs to 50 hrs to yield graphene aerogel. The obtained graphene aerogel maintains a three-dimensional structure with a large surface area, high electrical conductivity, excellent thermal stability, and robust mechanical properties.

In an embodiment, the deposition process involves preparing an electrolyte by combining a phosphorus-containing compound, a transition metal compound, disodium citrate, boric acid, and deionized water in predetermined proportions. The phosphorus-containing compound may include sodium hypophosphite monohydrate (NaH₂PO₂·H₂O), while the transition metal compound may be selected from sulfate salts of cobalt, nickel, iron, or zinc, such as cobalt sulfate heptahydrate (CoSO₄·7H₂O). The predetermined mass ratio of these components is in the range of (1-2):(1-2):(2-4):(1-2):(90-95), ensuring optimal composition for catalyst formation.

In an embodiment, the electrolyte comprises sodium hypophosphite, cobalt sulfate, sodium citrate, boric acid, and deionized water in a mass ratio of 1:1:2:1:95.

In an embodiment, the electrolyte comprises sodium hypophosphite, cobalt sulfate, nickel sulfate, sodium citrate, boric acid, and deionized water in a mass ratio of 1:1:1:2:1:94.

In an embodiment, the step of electro-depositing the metal phosphide nanoparticles onto the graphene aerogel is performed on a three-electrode system, wherein the three-electrode system comprises: the graphene aerogel as the working electrode, a titanium sheet electrode as the reference electrode, and a platinum electrode as the counter electrode.

In an embodiment, the electro-depositing is performed at a voltage of 2 V to 4 V, a frequency of 1 kHz to 100 kHz, a duty cycle of 20% to 40%, and an electrodeposition time of 10 minutes to 30 minutes.

In an embodiment, during the electro-depositing process, the graphene aerogel electrode serves as the working electrode, while a titanium sheet reference electrode and a platinum counter electrode are immersed in the electrolyte solution. The electrodeposition is carried out under a preset voltage of 2V to 4 V, with a frequency range of 1 kHz to 100 kHz, a duty cycle of 20% to 40%, and a deposition time of 10 minutes to 30 minutes. This process results in the formation of metal phosphide nanoparticles with an average size of approximately 5 nm on the graphene aerogel. The SAED analysis confirms that the nanoparticles exhibit a mixed crystalline phase.

It can be understood that under appropriate conditions, the nanoparticles are composed of transition metal phosphides, incorporating all metal elements introduced into the electrolyte solution. The specific composition and content of the nanoparticles vary depending on the electrolyte composition and electrodeposition conditions. By controlling relevant parameters, the composition and morphology of the nanoparticles can be precisely tuned.

In an embodiment, the electro-depositing is performed at a voltage of 3 V, a frequency of 50 kHz, a duty cycle of 30%, and an electrodeposition time of 20 minutes.

In an embodiment, under the above specific electro-depositing conditions, where the electrolyte comprising sodium hypophosphite, cobalt sulfate, sodium citrate, boric acid, and deionized water in a mass ratio of 1:1:2:1:95 is adopted, Co—P nanoparticles with an average size of 5 nm, exhibiting a spherical morphology can be electro-deposited on the graphene aerogel.

In an embodiment, under the above specific electro-depositing conditions, where the electrolyte comprising sodium hypophosphite, cobalt sulfate, nickel sulfate, sodium citrate, boric acid, and deionized water in a mass ratio of 1:1:1:2:1:94 is adopted, Co—Ni—P nanoparticles with an average size of 5 nm, exhibiting a spherical morphology can be electro-deposited on the graphene aerogel.

In a third aspect, an embodiment of the present application provides a hydrogen production system for hydrolysis of ammonia borane. The hydrogen production system comprises: a catalytic unit tube, configured to accommodate the metal phosphide-graphene aerogel catalyst provided by the first aspect of the present application or a catalyst prepared by the method for preparing the metal phosphide-graphene aerogel catalyst for hydrolysis of ammonia borane provided by the second aspect of the present application; a container, configured to accommodate an ammonia borane solution; a peristaltic pump, configured to drive a solution flow from the container to pass through the catalytic unit tube; liquid pipelines; and a gas collection system, connected via a gas pipe to the container to collect a hydrogen output. The container, the peristaltic pump, and the catalytic unit tube are sequentially connected via the liquid pipelines to form a circulation loop, such that the solution flow continuously circulates in the circulation loop under the driving of the peristaltic pump.

In the third aspect of the present application, the hydrogen production system comprises: a catalytic unit tube, configured to accommodate the metal phosphide-graphene aerogel catalyst provided by the first aspect of the present application or a catalyst prepared by the method for preparing the metal phosphide-graphene aerogel catalyst provided by the second aspect of the present application; a container, configured to accommodate an ammonia borane solution; a peristaltic pump, configured to drive a solution flow from the container to pass through the catalytic unit tube; liquid pipelines; and a gas collection system, connected via a gas pipe to the container to collect a hydrogen output. The container, the peristaltic pump, and the catalytic unit tube are sequentially connected via the liquid pipelines to form a circulation loop, such that the solution flow continuously circulates in the circulation loop under the driving of the peristaltic pump. The catalyst adopted is the metal phosphide-graphene aerogel composite catalyst provided by the present application, which has high structural stability, large surface area, and abundant active sites, thus providing enhanced catalytic performance. The system can operate at room temperature, making it suitable for both portable and stationary hydrogen generation applications. In this way, the hydrogen production system of the present application can efficiently catalyze ammonia borane hydrolysis while ensuring stability, reliability, and cost-effectiveness, accelerating the commercialization of hydrogen energy technologies.

In this embodiment, a hydrogen generation system is designed with an ammonia borane solution circulation system and utilizes a metal phosphide-graphene aerogel catalyst to stably and efficiently produce hydrogen, achieving a single-tube hydrogen production exceeding 60 mmol within five minutes.

In an embodiment, the metal phosphide-graphene aerogel catalyst in the catalytic unit tube are in the form of metal phosphide-graphene aerogel catalyst pieces.

In an embodiment, the metal phosphide-graphene aerogel catalyst pieces may have a diameter of 1.8 cm±0.2 cm and a thickness of 1.3 cm±0.2 cm.

In an embodiment, the system is equipped with controllable operational parameters, such as flow rate and catalyst loading, so as to realize stable and continuous hydrogen production, whereby maximize hydrogen yield and ensuring system safety.

In an embodiment, the system is operated at room temperature, which is adaptable to a portable or a stationary hydrogen generation application.

In an embodiment, 4 to 8 metal phosphide-graphene aerogel catalyst pieces are stacked vertically within the catalytic unit tube. The number of the metal phosphide-graphene aerogel catalyst pieces stacked within the catalytic unit tube can be adjusted according to the practical needs.

In an embodiment, a speed of the peristaltic pump is controlled within the range of 50 to 100 RPM. In this embodiment, the speed of the peristaltic pump speed can be adjustable within a range of 50 to 100 RPM, thereby optimizing solution flow rate for various production needs. In an embodiment, the speed of the peristaltic pump may be 50 RPM. In an embodiment, the speed of the peristaltic pump may be 60 RPM. In an embodiment, the speed of the peristaltic pump may be 70 RPM. In an embodiment, the speed of the peristaltic pump may be 80 RPM. In an embodiment, the speed of the peristaltic pump may be 90 RPM. In a preferable embodiment, the peristaltic pump operates at a flow rate of 100 RPM, ensuring sufficient contact between the catalyst and the ammonia borane aqueous solution.

In an embodiment, the gas collection system further comprises a gas measurement device for monitoring the hydrogen output.

In an embodiment, a plurality of catalytic unit tubes are provided, and the plurality of catalytic unit tubes are arranged in parallel, so as to improve the efficiency of hydrogen production. The number of the catalytic unit tubes are provided according to the practical needs, which are not limited herein in this application.

In an embodiment, the ammonia borane solution has a concentration of 0.53 g of ammonia borane per 100 ml of water.

In an embodiment, the peristaltic pump is operated for at least 30 minutes.

### EXAMPLES

### Example 1 Preparation of Graphene Aerogel

A graphene aerogel was prepared by as follows:
ascorbic acid as a reducing agent was added to a water-dispersed solution of graphene oxide after stirring at a speed of 600 RPM at room temperature (20° C.-25° C.) for 30 minutes. The mixture was then stirred for 1 hr at a speed of 600 RPM to ensure complete dissolution. A resulting solution was placed at 65° C. for 3 hrs to form a graphene hydrogel. This graphene hydrogel was pre-cooled at −60° C. for 2 hrs and then freeze-dried for 48 hrs, yielding the graphene aerogel.

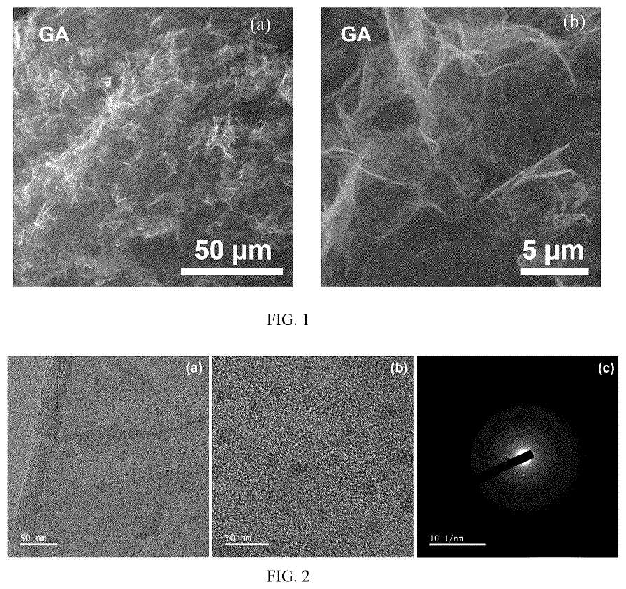

The obtained graphene aerogel possesses a three-dimensional structure with a large surface area high electrical conductivity, excellent thermal stability, and robust mechanical properties. FIG. 1 shows a scanning electron microscope (SEM) image of the graphene aerogel, specifically, part (a) of FIG. 1 is an SEM image of the graphene aerogel with a scale bar of 50 μm, and part (b) of FIG. 1 is an SEM image of the graphene aerogel with a scale bar of 5 μm.

### Example 2 Preparation of Electrolyte

### Example 2A

Sodium hypophosphite, cobalt sulfate, sodium citrate, boric acid, and deionized water in a mass ratio of 1:1:2:1:95 were combined and uniformly mixed to prepare an electrolyte solution.

### Example 2B

Sodium hypophosphite, cobalt sulfate, nickel sulfate, sodium citrate, boric acid, and deionized water in a mass ratio of 1:1:1:2:1:94 were combined and uniformly mixed to prepare an electrolyte solution.

### Example 3 Electro-Deposition

The graphene aerogel electrode prepared in Example 1 serving as the working electrode, while a titanium sheet reference electrode and a platinum counter electrode were immersed in the electrolyte solution. The electro-depositing was performed at a preset voltage of 3 V, a frequency of 50 kHz, a duty cycle of 30%, and an electrodeposition time of 20 minutes. Herein, the electrolyte solution prepared from Example 2A and Example 2B were respectively tried.

The prepared metal phosphide-graphene aerogel catalysts were respectively examined under HRTEM, and it was demonstrated that the electro-deposition process resulted in the formation of metal phosphide nanoparticles in a spherical morphology with an average size of approximately 5 nm on the graphene aerogel. The SAED analysis confirms that the nanoparticles exhibit a mixed crystalline phase.

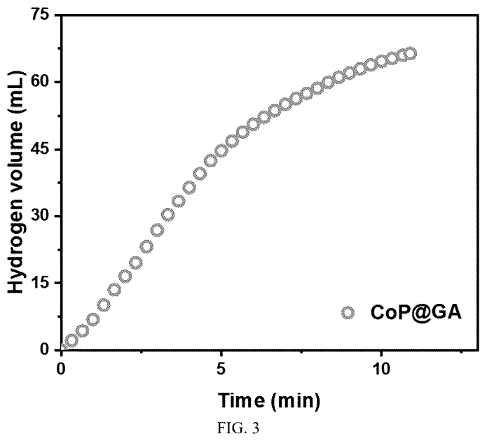

FIG. 2 shows a HRTEM image and an SAED pattern of the electrodeposited graphene aerogel. Specifically, part (a) of FIG. 2 is an HRTEM image of the electrodeposited graphene aerogel with a scale bar of 50 μm, part (b) of FIG. 2 is an HRTEM image of the electrodeposited graphene aerogel with a scale bar of 10 μm, and part (c) of FIG. 2 is an image showing the SAED pattern of the electrodeposited graphene aerogel.

### Example 4 Characterization of the Metal Phosphide-Graphene Aerogel Catalyst

The prepared metal phosphide-graphene aerogel catalysts in Example 3 were analyzed by energy dispersive X-ray spectroscopy (EDS).

TABLE 1
EDS results of metal phosphide-graphene aerogel catalyst
based on the electrolyte prepared in Example 2A

| Element | Weight % | Atomic % |
|---|---|---|
| C | 50.27 | 75.96 |
| O | 9.03 | 10.25 |
| P | 4.53 | 2.65 |
| Co | 36.17 | 11.14 |
| Totals | 100.00 | |

It was known from Table 1 that in the metal phosphide-graphene aerogel catalyst prepared based on the electrolyte solution in Example 2A, Co—P nanoparticles were supported on the graphene aerogel catalyst, the graphene aerogel accounts for 59.3 wt % of the catalyst, and the metal phosphide nanoparticles accounts for 40.7 wt % of the catalyst. An atomic ratio between phosphorus and the transitional metal element is about 1:4.2.

TABLE 2
EDS results of metal phosphide-graphene aerogel catalyst
based on the electrolyte prepared in Example 2B

| Element | Weight % | Atomic % |
|---|---|---|
| C | 54.57 | 73.92 |
| O | 17.26 | 17.55 |
| P | 2.93 | 1.54 |
| Co | 3.45 | 0.95 |
| Ni | 21.79 | 6.04 |
| Totals | 100.00 | |

It was known from Table 1 that in the metal phosphide-graphene aerogel catalyst prepared based on the electrolyte solution in Example 2B, Co—Ni—P nanoparticles were supported on the graphene aerogel catalyst, graphene aerogel accounts for 71.83 wt % of the catalyst, and the metal phosphide nanoparticles accounts for 28.17 wt % of the catalyst. An atomic ratio between phosphorus and the transitional metal element is about 1:4.5.

### Example 5 Catalytic Activity Test

The prepared catalysts were performed with catalytic activity test. 31.8 mg ammonia borane was completely dissolved in 6 mL deionized water to prepare an ammonia borane aqueous solution. A piece of the metal phosphide-graphene aerogel catalyst with a weight of the graphene aerogel substrate being 20 mg was placed in the ammonia borane aqueous solution. The generated hydrogen volume was measured over time.

FIG. 3 shows a plot of hydrogen generation versus time based on the Co—P@GA catalyst. It can be known from the result that about 45 mL of hydrogen was generated within 5 minutes, and about 65 mL of hydrogen was generated with 10 minutes.

### Example 6 Assemblage of Hydrogen Production System

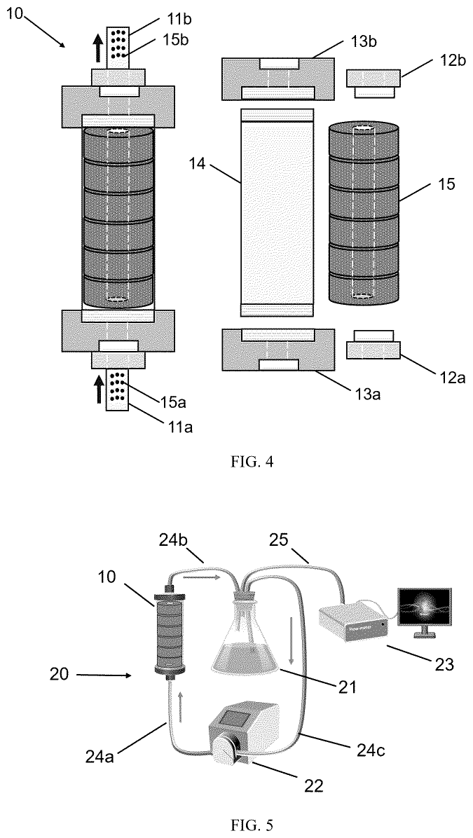

FIG. 4 shows a schematic diagram of the ammonia borane hydrolysis catalytic unit tube according to an embodiment of the present application. The catalytic unit tube 10 comprises: tube body 14, inlet and outlet liquid pipelines 11a, 11b, two pipe fixtures 12a, 12b, and connecting components 13a, 13b that link the liquid pipelines to the tube body 14. The tube body 14 houses the metal phosphide-graphene aerogel catalyst 15, herein, eight metal phosphide-graphene aerogel catalyst pieces were vertically stacked inside the catalytic unit tube, and each of the metal phosphide-graphene aerogel catalyst pieces had a diameter of 1.8 cm±0.2 cm and a thickness of 1.3 cm±0.2 cm. The inlet liquid pipe 11a is connected at the bottom of the tube body 14 and the outlet liquid pipe 11b is connected at the top of the tube body 14, so that it is constructed to introduce the ammonia borane solution 15a, 15b from bottom to top through the catalytic unit tube 10, thereby undergoing hydrolysis reaction to produce hydrogen gas.

FIG. 5 shows a schematic diagram of a hydrogen production system 20 for hydrolysis of ammonia borane according to an embodiment of the present application, illustrating the integrated components and system flow according to an embodiment of the present application. The hydrogen production system 20 for hydrolysis of ammonia borane is an ammonia borane solution circulation hydrogen generation system, and comprises: a catalytic unit tube 10, configured to accommodate the metal phosphide-graphene aerogel catalyst; a container 21, configured to accommodate an ammonia borane solution; a peristaltic pump 22, configured to drive a solution flow from the container to pass through the catalytic unit tube; a gas collection system 23, connected to the container 21 via a gas pipe 25 and configured to collect a hydrogen output. The gas collection system 23 is also provided with a gas flow meter and a computer system to monitor and analyze the hydrogen output. The catalytic unit tube 10 is connected to the peristaltic pump 22 via a liquid pipe 24a, and to the container 21 via a liquid pipe 24b. The ammonia borane solution container 21 is connected to the peristaltic pump 22 by a liquid pipe 24c and to the gas collection system 23 via the gas pipe 25. In this way, the container 21, the peristaltic pump 22, and the catalytic unit tube 10 are sequentially connected via the liquid pipelines 24a, 24b, 24c to form a circulation loop, such that the solution flow continuously circulates in the circulation loop under the driving of the peristaltic pump 22. The ammonia borane solution can circulate in turns of liquid pipelines 24a, 24b, and 24c, flow through the catalytic unit tube 10 to produce hydrogen, and the hydrogen gas can flow into the flow meter system 23 through gas pipe 25.

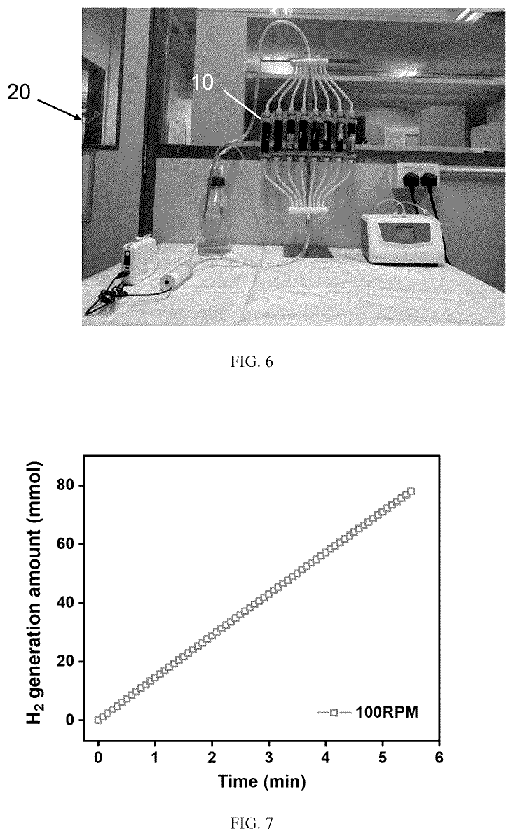

FIG. 6 shows an actual image of a hydrogen production system for hydrolysis of ammonia borane according to an embodiment of the present application. In this embodiment, eight catalytic unit tubes 10 are connected in parallel to form a larger catalytic section.

### Example 7 Hydrogen Production Based on the Hydrogen Production System

Catalytic ability testing was performed in the present application as mentioned below. Herein, the Co—P nanoparticles supported on the graphene aerogel catalyst prepared in Example 2A were tested.

The hydrogen production system was assembled, in which, eight metal phosphide-graphene aerogel catalyst pieces prepared from Example 2A were vertically stacked inside the catalytic unit tube, each of the metal phosphide-graphene aerogel catalyst pieces had a diameter of 1.8 cm±0.2 cm and a thickness of 1.3 cm±0.2 cm, and the ammonia borane solution container 21 contained 100 mL of ammonia borane solution containing 0.53 g of ammonia borane. The hydrogen production system was placed and operated at a room temperature. The peristaltic pump was started at a speed of 100 RPM to drive the liquid flow from the ammonia borane solution container 21 to pass through the catalytic unit tube 10. Once the ammonia borane solution achieved stable flow within the system, hydrogen evolution testing began. As shown in FIG. 7, the hydrogen yield increases steadily over time, with the single-tube system stably producing more than 60 mmol of hydrogen within five minutes.

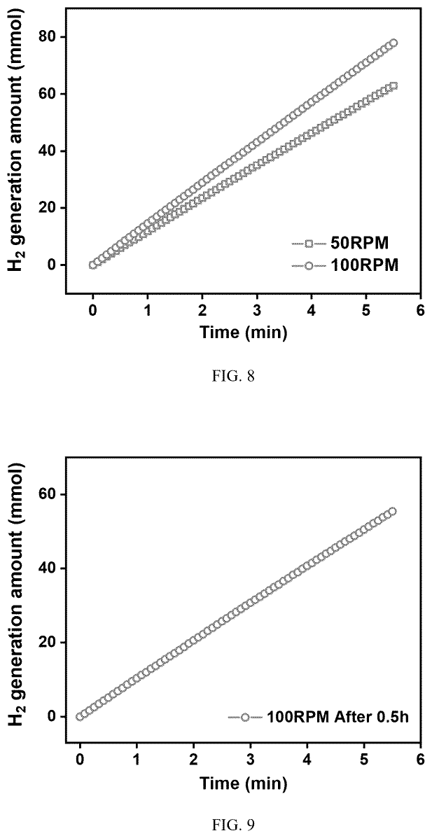

To compare the effect of different ammonia borane solution flow rates on hydrogen production rates, eight pieces of the metal phosphide-graphene aerogel catalyst prepared from Example 2A were placed inside the catalytic unit tube to facilitate the ammonia borane hydrolysis reaction. The peristaltic pump speed in the system was set to 50 RPM and 100 RPM, respectively. The system contained 100 mL of ammonia borane solution with 0.53 g of ammonia borane. Once stable flow of the ammonia borane solution was established within the system, hydrogen evolution testing commenced. As shown in FIG. 8, hydrogen production increases steadily over time at both flow rates, with faster flow rates resulting in quicker hydrogen generation. FIG. 8 shows a plot of hydrogen generation over time for a unit-tube catalyst at various flow rates.

To demonstrate the system's ability to continuously and stably hydrogen generation, eight pieces of the metal phosphide-graphene aerogel catalyst prepared from Example 2A were placed inside the catalytic unit tube to catalyze the ammonia borane hydrolysis reaction. The peristaltic pump speed was set to 100 RPM, using 100 mL of ammonia borane solution containing 0.53 g of ammonia borane. After circulating the ammonia borane solution in the system for half an hour, hydrogen production rates were measured. As shown in FIG. 9, hydrogen production remained stable, with the system still producing 50 mmol of hydrogen within five minutes after the half-hour cycle.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

What is claimed is:

1. A metal phosphide-graphene aerogel catalyst for hydrolysis of ammonia borane, comprising:
a graphene aerogel in a three-dimensional porous structure, and
metal phosphide nanoparticles, which are uniformly deposited on the graphene aerogel and comprise a phosphorus element and a transition metal element;
wherein
the transition metal element is at least one selected from the group consisting of cobalt, nickel, iron, zinc, titanium, vanadium, chromium, manganese, copper, or any combination thereof; and
the metal phosphide nanoparticles exhibit spherical morphologies and have an average particle size of between 3 nm and 200 nm.

2. The metal phosphide-graphene aerogel catalyst according to claim 1, wherein the transition metal element is at least one selected from the group consisting of cobalt, nickel, iron, zinc, or a combination thereof.

3. The metal phosphide-graphene aerogel catalyst according to claim 1, wherein the metal phosphide nanoparticles are Co—Ni—P nanoparticles.

4. The metal phosphide-graphene aerogel catalyst according to claim 1, wherein the metal phosphide nanoparticles are Co—P nanoparticles.

5. The metal phosphide-graphene aerogel catalyst according to claim 2, wherein an atomic ratio of the phosphorus element to the transition metal element is between (1:10) and (3:1).

6. The metal phosphide-graphene aerogel catalyst according to claim 5, wherein the metal phosphide nanoparticles that exhibit spherical morphologies have an average particle size of 5 nm.

7. A method for preparing the metal phosphide-graphene aerogel catalyst for hydrolysis of ammonia borane according to claim 1, the method comprising:
preparing the graphene aerogel by performing a hydrothermal process on a graphene oxide and a reducing agent; wherein the reducing agent is one selected from ascorbic acid, hydrazine hydrate, or sodium borohydride;
preparing an electrolyte, comprising a phosphorus-containing compound, a transition metal compound, disodium citrate, boric acid, and deionized water in a mass ratio of (1-2):(1-2):(2-4):(1-2):(90-95); and
electro-depositing the metal phosphide nanoparticles onto the graphene aerogel, thereby obtaining the metal phosphide-graphene aerogel catalyst.

8. The preparation method according to claim 7, wherein the step of preparing the graphene aerogel by performing the hydrothermal process on the graphene oxide and the reducing agent comprises:
adding the reducing agent to an aqueous dispersion solution of the graphene oxide and stirring until the reducing agent is completely dissolved;
heating a resulting mixed solution at a temperature of 60° C. to 70° C. for 3 hrs to 4 hrs to obtain a graphene hydrogel; and
pre-cooling the graphene hydrogel at a temperature of −55° C. to −60° C. for 2 hrs to 3 hrs, followed by freeze-drying for 48 hrs to 50 hrs, whereby obtaining the graphene aerogel.

9. The preparation method according to claim 8, wherein, prior to adding the reducing agent, the aqueous dispersion solution of the graphene oxide is stirred at room temperature at a speed of 500 RPM to 700 RPM for at least 30 minutes.

10. The preparation method according to claim 9, wherein the reducing agent is added to the aqueous dispersion solution of graphene oxide and stirred at room temperature at a speed of 500 RPM to 700 RPM for at least 1 hr.

11. The preparation method according to claim 7, wherein the electrolyte comprises sodium hypophosphite, cobalt sulfate, sodium citrate, boric acid, and deionized water in a mass ratio of 1:1:2:1:95.

12. The preparation method according to claim 7, wherein the electrolyte comprises sodium hypophosphite, cobalt sulfate, nickel sulfate, sodium citrate, boric acid, and deionized water in a mass ratio of 1:1:1:2:1:94.

13. The preparation method according to claim 7, wherein the step of electro-depositing the metal phosphide nanoparticles onto the graphene aerogel is performed on a three-electrode system, wherein the three-electrode system comprises:
the graphene aerogel as a working electrode,
a titanium sheet electrode as a reference electrode, and
a platinum electrode as a counter electrode.

14. The preparation method according to claim 13, wherein the electro-depositing is performed at a voltage of 2 V to 4 V, a frequency of 1 kHz to 100 kHz, a duty cycle of 20% to 40%, and an electrodeposition time of 10 minutes to 30 minutes.

15. The preparation method according to claim 14, wherein the electro-depositing is performed at a voltage of 3 V, a frequency of 50 kHz, a duty cycle of 30%, and an electrodeposition time of 20 minutes.

16. A hydrogen production system for hydrolysis of ammonia borane, comprising:
a catalytic unit tube, configured to accommodate the metal phosphide-graphene aerogel catalyst according to claim 1;
a container, configured to accommodate an ammonia borane solution;
a peristaltic pump, configured to drive a solution flow from the container to pass through the catalytic unit tube;
liquid pipelines; and
a gas collection system, connected via a gas pipe to the container and configured to collect a hydrogen output;
wherein
the container, the peristaltic pump, and the catalytic unit tube are sequentially connected via the liquid pipelines to form a circulation loop, such that a solution flow continuously circulates in the circulation loop under the driving of the peristaltic pump.

17. The hydrogen production system according to claim 16, wherein the metal phosphide-graphene aerogel catalyst in the catalytic unit tube are in the form of metal phosphide-graphene aerogel catalyst pieces, and 4 to 8 metal phosphide-graphene aerogel catalyst pieces are stacked vertically within the catalytic unit tube.

18. The hydrogen production system according to claim 16, wherein the gas collection system is further configured for monitoring the hydrogen output.

19. The hydrogen production system according to claim 17, wherein the catalytic unit tube is one of a plurality of catalytic unit tubes, and the plurality of catalytic unit tubes are arranged in parallel.

20. The hydrogen production system according to claim 17, wherein a speed of the peristaltic pump is controlled within a range of 50 to 100 RPM.
